(19) United States
(12) Patent Application Publication
(10) Pub. No.: US 2015/0009309 A1
(43) Pub. Date: Jan. 8, 2015

(54) Optical Frame for Glasses and the Like with Built-In Camera and Special Actuator Feature

(71) Applicants: Mitchell Heinrich, San Francisco, CA (US); Liang-Yu (Tom) Chi, San Francisco, CA (US)

(72) Inventors: Mitchell Heinrich, San Francisco, CA (US); Liang-Yu (Tom) Chi, San Francisco, CA (US)

(73) Assignee: GOOGLE INC., Mountain View, CA (US)

(21) Appl. No.: 13/178,740

(22) Filed: Jul. 8, 2011

(51) Int. Cl. H04N 7/18

(52) U.S. Cl. 348/61; 348/E07.085

(57) ABSTRACT

Optical glasses, as well as other eyewear, are provided with a frame that has a camera button located on a part of the glasses frame most preferably centered just above one of the lenses.

### FIELD OF THE DISCLOSURE

The present disclosure relates to optical glasses, goggles and like eyewear having a camera associated with the eyewear, as on the frame, and in particular a digital camera built-into the frame.

### BACKGROUND

Computing devices such as personal computers, laptop computers, tablet computers, cellular phones, and countless types of Internet-capable devices are increasingly prevalent in numerous aspects of modern life. As computers become more advanced, augmented-reality devices, which blend computer-generated information with the user's perception of the physical world, are expected to become more prevalent.

To provide an augmented-reality experience, computing devices may be worn by a user as they go about various aspects of their everyday life. Such computing devices may be “wearable” computers. Wearable computers may sense a user's surrounding by, for example, determining a user's geographic location, using cameras and/or sensors to detect objects near to the user, using microphones and/or sensors to detect what a user is hearing, and using various other sensors to collect information about the environment surrounding the user. Further, wearable computers may use biosensors to detect the user's own physical state. The information collected by the wearable computer may then be analyzed in order to determine what information should be presented to the user.

A wearable computer may take the form of a head-mounted display (HMD) that is worn by the user. An HMD typically provides a heads-up display near the user's eyes. As such, HMDs may also be referred to as “near-eye” displays. HMDs may overlay computer-generated graphics (e.g., text, images, video, etc.) on the physical world being perceived by the user. An HMD may also include a camera that is associated with the HMD, as on the frame of a pair of glasses, goggles or the like.

Moreover, the camera need not be part of an overall wearable computer associated with the eyewear, but could be a camera built into what might otherwise be a fairly standard optical eyeglass frame. The camera may be a miniature digital camera that is incorporated in the eyeglass frame, thus eliminating the need to carry the camera. How to actuate the camera can be an important feature.

### SUMMARY

In one aspect of the present disclosure, eyewear is provided having a frame adapted to be secured to a wearer's head. The frame includes a frame part that is located just above a wearer's eye. A digital camera is mounted to the frame. There is a power source for the camera, as well as a storage device configured to store digital images taken by the camera.

An actuator for operating the camera is provided on the frame part, and positioned approximately just above a wearer's eye.

In another aspect of the present disclosure, optical glasses are provided with a frame that has a camera button located on a part of the glasses frame, most preferably approximately centered just above one of the lenses. By approximately centered is meant generally along a vertical line extending through the midpoint of the eyeball, but with some small latitude left or right of this line. This places the button in a position that (1) is easily accessed by the wearer while also serving to stabilize the glass frame/picture image, and (2) an individual having his/her picture taken will recognize a traditional “picture taking” gesture by the wearer, thus serving as a “visual cue” to the subject; as the top and bottom of the glasses lens is held like a standard camera, with finger on the button, and the wearer's eye in the lens is reminiscent of a camera lens.

The disclosure is not limited to glasses, but is applicable to other eyewear, such as goggles, which present a similar framework on which the novel button placement can be accomplished. Nor is the disclosure limited to a push button, and other actuator devices may be readily employed. So too, the camera may be for still photos or video.

These and other aspects, advantages and features of the disclosure will be further understood upon consideration of the following detailed description of an embodiment of the disclosure, taken in conjunction with the drawings, in which:

### BRIEF DESCRIPTION OF THE DRAWINGS

FIG. 1 is a perspective view of a pair of optical glasses having a built-in digital camera with an actuator button located in accordance with an example embodiment;

FIG. 2 is a similar view of the glasses of FIG. 1, here shown being worn by a user in the act of taking an image of a scene (picture);

FIG. 3 illustrates another embodiment which further provides an example system for receiving, transmitting, and displaying data;

FIG. 4 illustrates an alternate view of the system of FIG. 3; and

FIG. 5 illustrates an example schematic drawing of a computer network infrastructure.

### DETAILED DESCRIPTION OF EMBODIMENTS

The following detailed description describes various features and functions of the disclosure with reference to the accompanying Figures. In the Figures, similar symbols typically identify similar components, unless context dictates otherwise. The illustrative apparati described herein are not meant to be limiting. It will be readily understood that certain aspects of the disclosure can be arranged and combined in a wide variety of different configurations, all of which are contemplated herein.

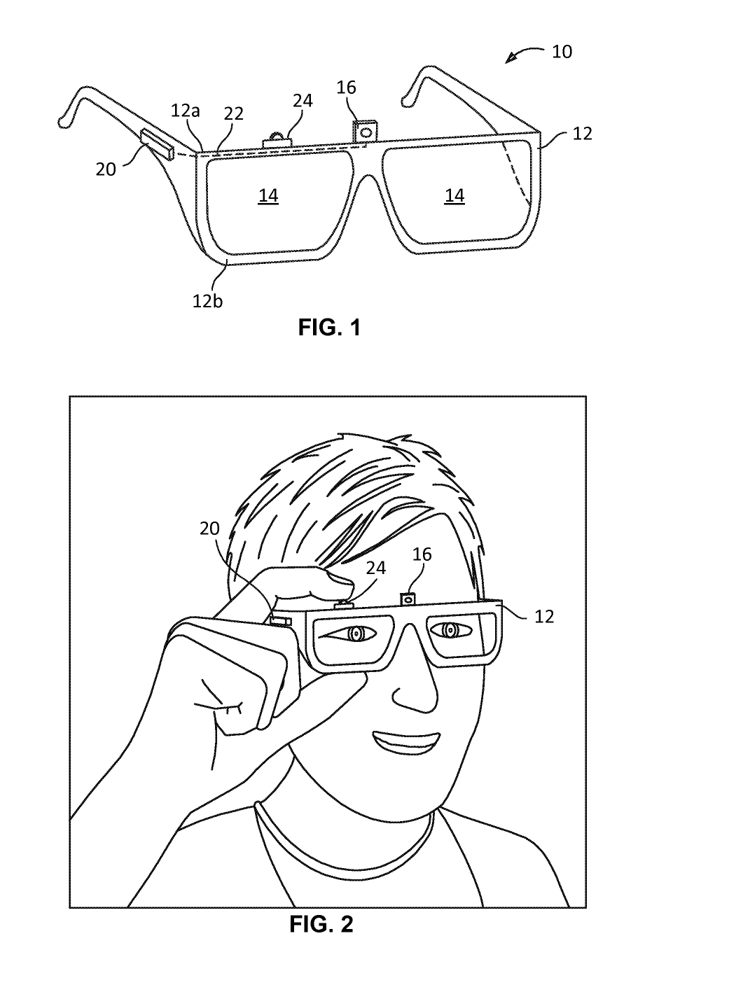

FIG. 1 shows a wearable pair of glasses 10, having a frame 12 for lenses 14. The glasses are conventional in this first embodiment, but as previously noted, the disclosure has broader application to other eyewear, such as goggles and the like.

Mounted on frame 12 is a digital camera 16. Camera 16 is connected with a power source and image storage device 20, via a suitable wire electrical connection indicated at 22. The wire may be located within the frame 12, for example. Note also that the camera could be wirelessly connected to a power source and image storage device remote from the frame 12, if so desired.

Here, the camera 16 is mounted so that it is positioned and oriented in the same direction as the user's eyes to capture a view similar to the wearer's view. Other configurations are also possible. Mounted as such, the camera tracks the movement of the user's head. If a video camera is used instead of a still photo camera, the perspective of the recorded video at a given point in time will generally capture the user's frame of reference (i.e., the user's view) at that time.

The digital camera 16 is of a known conventional type, including a lens for focusing on the subject, a digital imager for capturing an image, and a converter for producing digital image signals from the image. The storage device 20 is likewise known and conventional, having a battery also associated therewith for powering the apparatus. Again, such digital cameras and related equipment are well known in the art.

The actuator for the camera 16 is a push button 24. Button 24 is located on the frame 12 at about the midpoint on the upper part 12a of the frame above a lens 14. This places the button 24 in a very useful position. With reference to FIG. 2, button 24 is readily actuated by the wearer holding the frame 12 with a thumb on the lower part 12b of the frame and the “pointing” finger opposed to the thumb and on the button 24.

This orientation of the button 24 also is reminiscent of how a person would ordinarily hold a stand-alone camera for taking a photo (such as a camera having dimensions of about two inches tall and three inches long), looking through the viewfinder with one eye. So too, the perception of the person whose photo is being taken will be like that dealing with an ordinary camera. Thus, placing the button 24 in the indicated position on the upper frame part 12a provides a visual “cue” to the subject that a photo-shoot is in progress.

Button 24 is likewise known and conventional. It may be such as to provide a mechanical switch to operate the camera, or simply an electrical signal to do the same. It may be a touchswitch (resistive or capacitive sensitive), or an optical or proximity sensor with no moving parts. Furthermore, button 24 may also perform an on-off function for the camera 16, using conventional circuitry which determines on/off by the length of time the button is held, for example. Alternatively, another actuator may be associated with the frame 12, as on the storage device 20, which is used for turning the camera on and off.

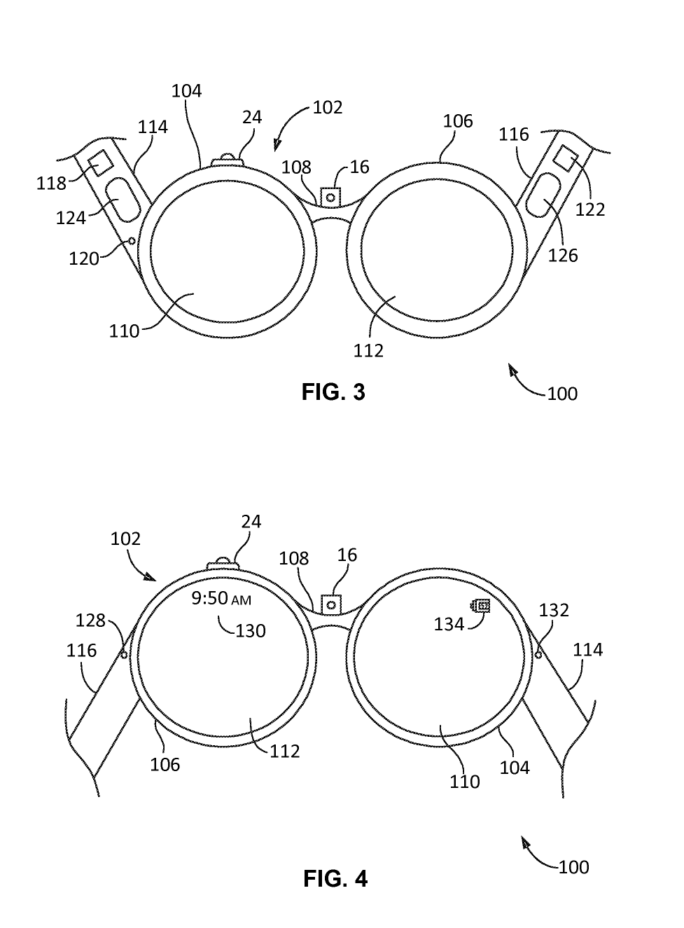

Turning now to FIG. 3, this illustrates another embodiment which has been implemented in an example system 100 for receiving, transmitting, and displaying data. The system 100 is shown in the form of a wearable computing device, or HMD. FIG. 3 illustrates eyeglasses 102 as an example of a wearable computing device, but other types of wearable computing devices could additionally or alternatively be used, such as goggles.

As illustrated in FIG. 3, the eyeglasses 102 comprise frame elements including lens-frames 104 and 106 and a center frame support 108, lens elements 110 and 112, and extending side-arms 114 and 116. The center frame support 108 and the extending side-arms 114 and 116 are configured to secure the eyeglasses 102 to a user's face via a user's nose and ears, respectively. Each of the frame elements 104, 106, and 108 and the extending side-arms 114 and 116 may be formed of a solid structure of plastic and/or metal, or may be formed of a hollow structure of similar material so as to allow wiring and component interconnects to be internally routed through the eyeglasses 102. Each of the lens elements 110 and 112 may be formed of any material that can suitably display a projected image or graphic. Each of the lens elements 110 and 112 may also be sufficiently transparent to allow a user to see through the lens element. Combining these two features of the lens elements can facilitate an augmented reality or heads-up display where the projected image or graphic is superimposed over a real-world view as perceived by the user through the lens elements.

Camera 16 is mounted on the center frame support 108.

The extending side-arms 114 and 116 are each projections that extend away from the frame elements 104 and 106, respectively, and are positioned behind a user's ears to secure the eyeglasses 102 to the user. The extending side-arms 114 and 116 may further secure the eyeglasses 102 to the user by extending around a rear portion of the user's head. Additionally or alternatively, for example, the system 100 may connect to or be affixed within a head-mounted helmet structure. Other possibilities exist as well.

The system 100 may also include an on-board computing system 118, a video camera 120, a sensor 122, and finger-operable touch pads 124, 126. The on-board computing system 118 is shown to be positioned on the extending side-arm 114 of the eyeglasses 102; however, the on-board computing system 118 may be provided on other parts of the eyeglasses 102 or even remote from the glasses (e.g., computing system 118 could be connected wirelessly or wired to eyeglasses 102). The on-board computing system 118 may include a processor and memory, for example. The on-board computing system 118 may be configured to receive and analyze data from the video camera 120 and the finger-operable touch pads 124, 126 (and possibly from other sensory devices, user interfaces, or both) and generate images for output from the lens elements 110 and 112. The camera 16 is connected to the computing system 118, which would also include the power source (battery) and image storage capability.

The video camera 120 is shown to be positioned on the extending side-arm 114 of the eyeglasses 102; however, the video camera 120 may be provided on other parts of the eyeglasses 102; as noted previously, the video camera could replace the camera 16. The video camera 120 may be configured to capture images at various resolutions or at different frame rates. Many video cameras with a small form-factor, such as those used in cell phones or webcams, for example, may be incorporated into an example of the system 100. Although FIG. 3 illustrates one video camera 120, more video cameras may be used, and each may be configured to capture the same view, or to capture different views. For example, the video camera 120 may be forward facing to capture at least a portion of the real-world view perceived by the user. This forward facing image captured by the video camera 120 may then be used to generate an augmented reality where computer generated images appear to interact with the real-world view perceived by the user.

The sensor 122 is shown mounted on the extending side-arm 116 of the eyeglasses 102; however, the sensor 122 may be provided on other parts of the eyeglasses 102. The sensor 122 may include one or more of a gyroscope or an accelerometer, for example. Other sensing devices may be included within the sensor 122 or other sensing functions may be performed by the sensor 122.

The finger-operable touch pads 124, 126 are shown mounted on the extending side-arms 114, 116 of the eyeglasses 102. Each of finger-operable touch pads 124, 126 may be used by a user to input commands. The finger-operable touch pads 124, 126 may sense at least one of a position and a movement of a finger via capacitive sensing, resistance sensing, or a surface acoustic wave process, among other possibilities. The finger-operable touch pads 124, 126 may be capable of sensing finger movement in a direction parallel or planar to the pad surface, in a direction normal to the pad surface, or both, and may also be capable of sensing a level of pressure applied. The finger-operable touch pads 124, 126 may be formed of one or more translucent or transparent insulating layers and one or more translucent or transparent conducting layers. Edges of the finger-operable touch pads 124, 126 may be formed to have a raised, indented, or roughened surface, so as to provide tactile feedback to a user when the user's finger reaches the edge of the finger-operable touch pads 124, 126. Each of the finger-operable touch pads 124, 126 may be operated independently, and may provide a different function.

FIG. 4 illustrates an alternate view of the system 100 of FIG. 3. As shown in FIG. 4, the lens elements 110 and 112 may act as display elements. The eyeglasses 102 may include a first projector 128 coupled to an inside surface of the extending side-arm 116 and configured to project a display 130 onto an inside surface of the lens element 112. Additionally or alternatively, a second projector 132 may be coupled to an inside surface of the extending side-arm 114 and configured to project a display 134 onto an inside surface of the lens element 110.

The lens elements 110 and 112 may act as a combiner in a light projection system and may include a coating that reflects the light projected onto them from the projectors 128 and 132. In some embodiments, a special coating may not be used (e.g., when the projectors 128 and 132 are scanning laser devices).

In alternative embodiments, other types of display elements may also be used. For example, the lens elements 110, 112 themselves may include: a transparent or semi-transparent matrix display, such as an electroluminescent display or a liquid crystal display, one or more waveguides for delivering an image to the user's eyes, or other optical elements capable of delivering an in focus near-to-eye image to the user. A corresponding display driver may be disposed within the frame elements 104 and 106 for driving such a matrix display. Alternatively or additionally, a laser or LED source and scanning system could be used to draw a raster display directly onto the retina of one or more of the user's eyes. Other possibilities exist as well.

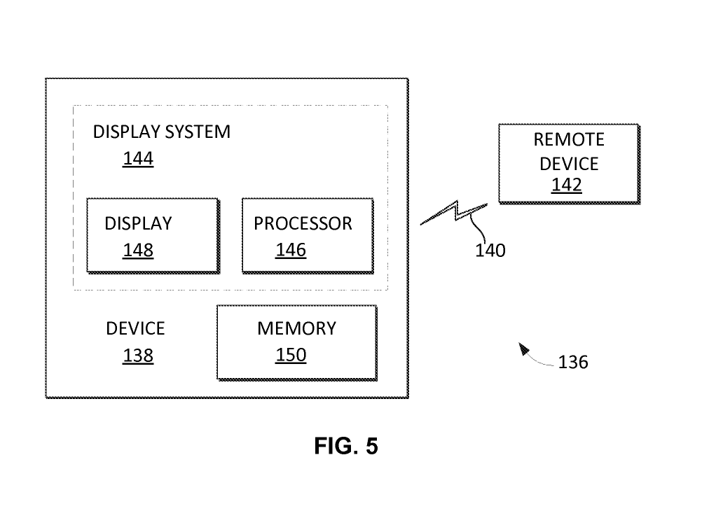

FIG. 5 illustrates an example schematic drawing of a computer network infrastructure. In one system 136, a device 138 communicates using a communication link 140 (e.g., a wired or wireless connection) to a remote device 142. The device 138 may be any type of device that can receive data and display information corresponding to or associated with the data. For example, the device 138 may be a heads-up display system, such as the eyeglasses 102 described with reference to FIGS. 1 and 2.

Thus, the device 138 may include a display system 144 comprising a processor 146 and a display 148. The display 148 may be, for example, an optical see-through display, an optical see-around display, or a video see-through display. The processor 146 may receive data from the remote device 142, and configure the data for display on the display 148. The processor 146 may be any type of processor, such as a micro-processor or a digital signal processor, for example.

The device 138 may further include on-board data storage, such as memory 150 coupled to the processor 146. The memory 150 may store software that can be accessed and executed by the processor 146, for example.

The remote device 142 may be any type of computing device or transmitter including a laptop computer, a mobile telephone, etc., that is configured to transmit data to the device 138. The remote device 142 and the device 138 may contain hardware to enable the communication link 140, such as processors, transmitters, receivers, antennas, etc.

In FIG. 5, the communication link 140 is illustrated as a wireless connection; however, wired connections may also be used. For example, the communication link 140 may be a wired link via a serial bus such as a universal serial bus or a parallel bus. A wired connection may be a proprietary connection as well. The communication link 140 may also be a wireless connection using, e.g., Bluetooth® radio technology, communication protocols described in IEEE 802.11 (including any IEEE 802.11 revisions), Cellular technology (such as GSM, CDMA, UMTS, EV-DO, WiMAX, or LTE), or Zigbee® technology, among other possibilities. The remote device 142 may be accessible via the Internet and may comprise a computing cluster associated with a particular web service (e.g., social-networking, photo sharing, address book, etc.).

While various aspects of the disclosure have been disclosed herein, other aspects and embodiments will be apparent to those skilled in the art. Accordingly, the embodiments disclosed herein are for purposes of illustration, and are not intended to be limiting, with the true scope and spirit of the disclosure being indicated by the following claims.

1. A head-mountable device, comprising:
a frame adapted to be secured to a wearer's head, said frame having a frame part that is located just above a wearer's eye;
a camera mounted to said frame, wherein the camera is mounted on said frame such that when the head-mountable device is worn, the camera is located above a nose;
a power source for said camera;
a storage device configured to store digital images taken by said camera;
an actuator for operating said camera to capture image data, said actuator being on an upper surface of said frame part, such that when the head-mountable device is worn, the actuator is positioned above an eye, and such that operation of said button results in at least one finger being within a peripheral field of view of the eye; and
a video projector mounted to said frame and used to project images upon the inside of a lens mounted within said frame.

2. The head-mountable device of claim 1, wherein said power source and storage device are carried by said frame.

3. The head-mountable device of claim 1, wherein said actuator is a button.

4. A pair of optical glasses having a frame supporting a pair of lenses, comprising:
a camera mounted on said glasses frame, wherein said camera is mounted on said frame at a point above a wearer's nose;
a power source and digital image storage device mounted on said glasses frame;
a video projector mounted to said glasses frame and used to project images upon the inside of a lens mounted within said glasses frame;
a camera button located on an upper surface of a part of said glasses frame and centered just above one of said lenses, said button operating said camera to take images, such that said button is in a position that is operable by a grasp of said frame with a thumb on said frame below said one lens with another finger above said one lens on said button, serving to stabilize said frame for image-taking, wherein the operation of said button results in at least one finger being within a peripheral field of view of the eye.

5. Eyewear, comprising:
a frame adapted to be secured to a wearer's head, said frame having a frame part that is located above a wearer's eye;
a camera mounted to said frame, wherein the camera is mounted on said frame such that when the head-mountable device is worn, the camera is located above a nose;
a power source for said camera;
a storage device configured to store images taken by said camera;
a video projector mounted to said frame and used to project images upon the inside of a lens mounted within said frame;
an actuator for operating said camera to capture image data, said actuator being arranged on an upper surface of said frame part, such that when the eyewear is worn, the actuator is positioned substantially centered above a wearer's eye, and such that operation of said actuator results in at least one finger being within a peripheral field of view of the eye.

6. The eyewear of claim 5, wherein said power source and storage device are carried by said frame.

7. The eyewear of claim 6, further including a video camera.

8. The eyewear of claim 6 wherein said camera is a video camera.

9. The eyewear of claim 6 wherein said camera is a digital still photo camera.

10. The eyewear of claim 6, further including a computing system carried by said frame, said computing system comprising said storage device.

11. The eyewear of claim 10 wherein said camera is a video camera.

12. The eyewear of claim 10 wherein said camera is a digital still photo camera.

13. The eyewear of claim 6 wherein said button is mechanical press-actuated button.

14. The eyewear of claim 6 wherein said button is a touch-sensitive button.

15. The eyewear of claim 14 wherein said button is a touchpad.

16. (canceled)
